(19) United States
(12) Patent Application Publication
(10) Pub. No.: US 2023/0348180 A1
(43) Pub. Date: Nov. 2, 2023

(54) PET ACCESSORY FOR WASTE MANAGEMENT

(71) Applicant: Nyrobia Waldeiah Freeman, Lutz, FL (US)

(72) Inventor: Nyrobia Waldeiah Freeman, Lutz, FL (US)

(21) Appl. No.: 18/140,939

(22) Filed: Apr. 28, 2023

Related U.S. Application Data
(60) Provisional application No. 63/336,301, filed on Apr. 29, 2022.

(51) Int. Cl. B65F 1/00; B65D 33/00; B65D 33/14; B65D 33/28

(52) U.S. Cl. CPC B65F 1/002; B65D 33/004; B65D 33/14; B65D 33/28; A01K 27/008

(57) ABSTRACT

A selectively closable pet waste bag having a bag body is described herein. The bag body includes an outer layer made up of a front side and a back side. The bag body further includes an inner layer disposed within (e.g., nested within) the outer layer. The inner layer defines an inner pouch compartment therein and the inner pouch compartment has a selectively closable opening along one side. The inner layer is formed from a waterproof material. The outer layer comprises at least one pocket disposed thereon. A closing mechanism configured to selectively close the opening of the inner pouch.

### PRIORITY CLAIM

This application claims the benefit of priority of U.S. Provisional Patent Application No. 63/336,301, filed on Apr. 29, 2022, the entirety of which is incorporated herein by reference.

### SUMMARY OF THE DISCLOSURE

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

The present disclosure describes a selectively closable bag having a bag body. The bag body includes an outer layer made up of a front side and a back side. The bag body further includes an inner layer disposed within (e.g., nested within) the outer layer. The inner layer defines an inner pouch compartment therein and the inner pouch compartment has a selectively closable opening along one side. The inner layer is formed from a waterproof material. The outer layer comprises at least one pocket disposed thereon. A closing mechanism configured to selectively close the opening of the inner pouch.

The present disclosure further describes a selectively closable bag having a bag body. The bag body includes a front side, a back side, and an inner pouch compartment (e.g., between the front side and the back side which may be sealed along all sides except for an opening. The bag body includes a selectively closable opening (e.g., along a top side of the bag body). The bag body is formed from a waterproof material and includes at least one pocket disposed on an exterior surface of the bag body. A closing mechanism is included to selectively close the opening of the inner pouch.

### BRIEF DESCRIPTION OF THE DRAWINGS

The appended drawings illustrate only some implementations and are therefore not to be considered limiting of scope.

FIG. 1 illustrates a drawstring bag, in accordance with an embodiment.

FIG. 2 illustrates a front and back side of a selectively closable bag, in accordance with an embodiment.

FIGS. 3A-3B illustrate front and back views of a selectively closable bag, in accordance with an embodiment.

FIGS. 4A-4B illustrate front and back views of a selectively closable bag, in accordance with an embodiment.

FIGS. 5A-5B illustrate front and back views of a selectively closable bag, in accordance with an embodiment.

FIGS. 6A-6B illustrate front and back views of a selectively closable bag, in accordance with an embodiment.

FIGS. 7A-7B illustrate front and back views of a selectively closable bag, in accordance with an embodiment.

FIGS. 8A-8B illustrate front and back views of a selectively closable bag, in accordance with an embodiment.

### DETAILED DESCRIPTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “compromising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Many pet owners visit parks, restaurants, and other public spaces with their pets. While some pet-friendly public places may provide supplies such as waste pick-up bags and waste bins, in many cases, supplies and facilities are not available. In such instances, the pet owner is responsible for bringing their own pet supplies. For example, depending on the length and type of outing, pet owners may need to bring waste pick-up bags, water, a water or food bowl, treats, and other items. Other factors, such as weather and/or number of pets, may also factor into which supplies and how many supplies a pet owner brings on the outing.

In addition to bringing the supplies, a pet owner may also be responsible for storing pet waste until it can be discarded into a waste bin. Rolls of disposable plastic or biodegradable waste bags are available for this purpose. In instances when a waste bin is not readily accessible, pet owners may need to carry the bagged pet waste for a period of time. This experience is generally unpleasant for the pet owner as the waste odor may not be contained by the waste bag and germs and other biohazardous material from handling pet waste may transfer to the owner's hands. To solve these and other problems faced by pet owners, a novel pet bag is disclosed herein.

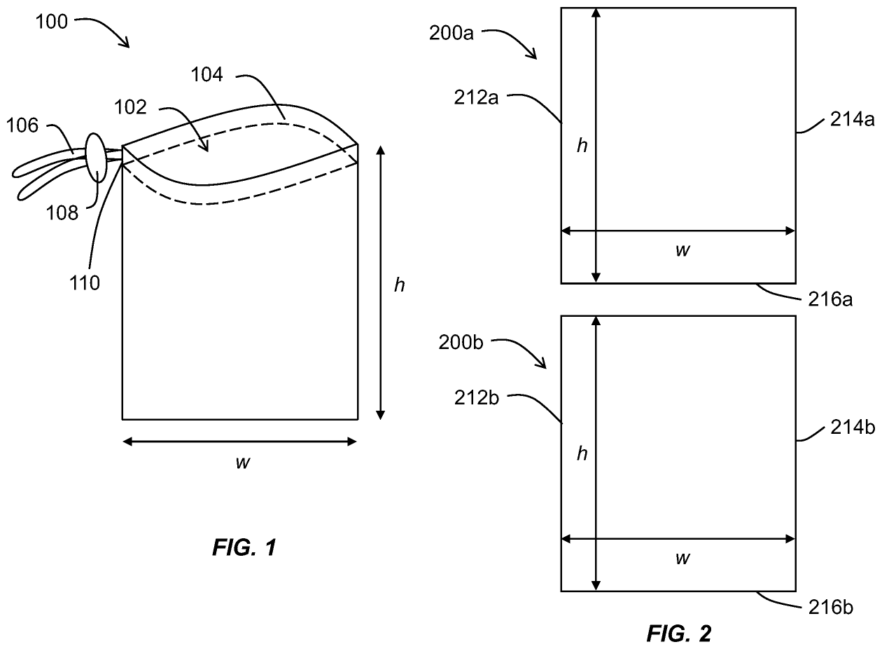

Referring to FIG. 1, a pet bag 100 is illustrated. The bag 100 has a height dimension, h, and a width dimension, w. The bag 100 includes a bag opening 102 that allows access to an inside volume of the bag. The bag opening 102 may be selectively opened and closed using any suitable mechanism. For example, bag 100 is illustrated with a channel 104, defined by a top edge of the bag and a seam where folded fabric is stitched, configured to allow one or more drawstrings 106 to pass therethrough. Ends of drawstrings 106 may be passed through a spring-loaded cord lock 108, lock, or other type of stopper. The drawstring 106 may have loose ends or may have closed ends (e.g., may form loops by being tied, melted, adhered, or braided together, etc.) such that the user may hang the drawstring around their wrist, for example. The bag opening 102 may be cinched closed by pulling a length of the drawstring 106 out of the channel 104 and securing the cord lock 108 near the channel opening 110. The bag may be opened by sliding the cord lock 108 toward the ends of drawstring 106 so that a larger length of drawstring 106 runs through the channel 104 and allows the bag opening 102 to become larger. Items may then be placed within or removed from the inside of bag 100. While a drawstring system is illustrated, other types of selectively closing mechanisms may be used to open and close bag opening 102, such as hook and loop, snaps, magnets, and/or zippers.

The bag 100 may be formed from one rectangle folded in half and stitched, or otherwise adhered, welded, or sealed, along at least two of the non-folded sides. Alternatively, the bag 100 may be formed from two rectangles (e.g., two substantially equally sized rectangles 200a, 200b) stitched, or otherwise adhered, welded, or sealed, together along three sides (e.g., sides 212a, 212b, 214a, 214b, 216a, and 216b of front side 200a and back side 200b as shown in FIG. 2). While rectangular bags are illustrated and described herein, this disclosure is not so limited, and the bags may take other shapes. For example, the bag may be trapezoidal, having either a larger base or a larger top, or may be rounded, polygonal, irregular, and/or curved in shape. Additionally, while the height, h, is generally shown as being larger than width, w, this is not a requirement. The width, w, may be equal to or larger than the height, h. Size and aspect ratios of the bag may be selected as a matter of design choice. In general, the width of bags described herein may be between approximately 6 inches and approximately 12 inches; the height of bags described herein may be between approximately 8 inches and approximately 16 inches. As will be discussed in embodiments herein, larger sized bags may have room to fit additional storage pockets and other features thereon. Additionally, larger sized bags with more interior storage capacity may be preferred by pet owners with multiple pets or pet owners who carry many supplies.

Bag 100, as well as any of the bags described herein, may be made entirely from or may be lined with a waterproof material, such as a vinyl fabric. The vinyl or other waterproof material (e.g., plastic, silicone, etc.) defines the large inner pocket (e.g., the space formed by stitching, folding, or otherwise sealing three sides of the front and back pieces of the bag together) so that used waste bags may be deposited therein and the contents of the waste bags will be fully contained by the waterproof fabric without risk of contents leaking out. An additional advantage to the use of a waterproof fabric is the reduction in odor associated with carrying the used pet waste bags as well as the containment of biohazardous material. The reduction in odor is an important feature of the embodiments disclosed herein, as carrying odorous pet waste is an unpleasant experience for pet owners and this aspect of the pet ownership experience has not been addressed by products on the market. In addition to containing biohazardous waste and odor, the vinyl material prevents biohazardous contents therein from being absorbed as would occur with a more permeable fabric (e.g., a woven fabric or a natural fiber fabric), thereby making the bag easy to rinse and clean for improved hygiene. While vinyl is readily available and easy to use, other waterproof materials may also be used such as plastic, silicone, or other flexible waterproof materials. In some embodiments, the waterproof lining of the bag is permanently integrated with the bag (e.g., may be stitched to or otherwise secured to an outer lining). In other embodiments, the waterproof lining of the bag may be selectively removable (e.g., using snaps, hook and loop, or other fasteners). In such removable lining configurations, a user may have multiple liners that can be rotated or alternated into the bag (e.g., remove and wash a first liner while a second is installed and used or vice versa). The user may also replace the removable waterproof liners over time if they become damaged or worn in order to maintain optimal cleanliness of the bag.

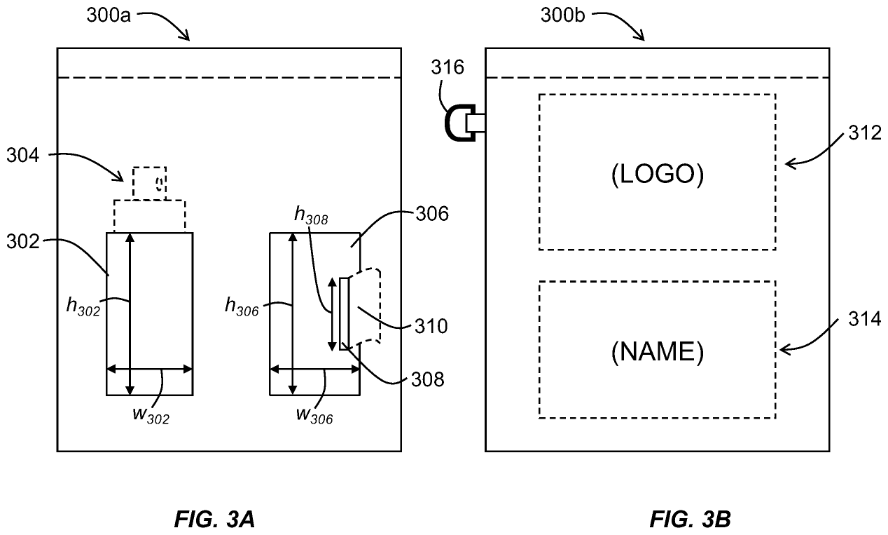

Referring to FIGS. 3A and 3B together, a front side 300a and a back side 300b, respectively, of a bag are illustrated. The front side 300a and back side 300b may be stitched, glued, or otherwise sealed together along three of the four sides (e.g., the left, right, and bottom sides) to create a bag having a large inner pocket. The bag may be any size, for example, approximately seven inches in width by approximately ten inches in height. In this embodiment, the front side 300a includes a plurality of features integrated therewith or affixed thereon (e.g., by stitching, adhesives, or other permanent or selectively removable means). In this example, the features include a pocket 302 sized and configured to receive a hand sanitizer gel or spray bottle 304. The pocket 302 has a height h₃₀₂ and a width w₃₀₂. In some embodiments, height h₃₀₂ may be between approximately 3 inches and approximately 6 inches and width w₃₀₂ may be between approximately 1.5 inches and approximately 3 inches to receive and securely hold a small bottle. The pocket 302 includes an opening at the top (e.g., along a width side) to receive the bottle 304. In some embodiments, the pocket may be sized and configured to receive a liquid soap or disinfectant spray bottle, depending on the needs of the user. While the pocket 302 is illustrated as rectangular, any suitable shape may be selected to receive a container or bottle 304. The front side 300a of the bag also includes a waste bag roll pocket 306. Similar to pocket 302, the pocket 306 has a height h₃₀₆ and a width w₃₀₆. In some embodiments, height h₃₀₆ may be between approximately 3 inches approximately 6 inches, and width w₃₀₆ may be between approximately 2 inches and approximately 4 inches to receive and securely hold a roll of unused waste bags. Pocket 306 includes a top opening (e.g., along a width side) configured to receive a roll of waste bags into the pocket. The top openings of pocket 302 and pocket 306 may be along the same (e.g., a top) side of the pockets so that both pockets receive items in the same way (e.g., by sliding items top-down into the pockets). A slit 308 may be included in the pocket 306 to allow easy dispensing of unused waste bags 310 therethrough. The slit 308 has a height h₃₀₈ and the height h₃₀₈ may be between approximately 0.5 inches and approximately 1.5 inches in height to allow the next waste bag 310 on the roll of unused waste bags disposed on the pocket 306 to pass easily therethrough. For example, the height of slit 308 may be approximately 1 inch. A width of the slit 308 is sufficiently small so that the roll of waste bags within pocket 306 is not pulled through the slit while the user is pulling out or tearing a bag off of the roll for use.

Back side 300b of the bag may also include one or more features integrated therewith or affixed thereon. In the example shown, a first area 312 of the bag may be reserved for the placement of a logo, picture, text, or other graphic design. The design may be added to the bag by screen printing, stitching and/or adhering of one or more patches, embroidering, painting, and/or applying colors, patterns, branding and/or decorative materials using any suitable means. Similarly, a second area 314 may be reserved for placement of a name, such as a pet name or an owner's name. Other decoration or branding may be included instead of or in addition to the name.

The bag formed from the assembly of front side 300a and back side 300b may also include a tab, hook, ring, clasp, clip, loop, handle or other feature that may be used to secure the bag to a belt, pet leash, or strap. In the embodiment shown in FIG. 3B, the back side 300b includes a metal or plastic D-ring 316 that may be directly or indirectly coupled to the bag material. In other embodiments, the D-ring may be replaced with a carabiner, circular ring, or other hardware. This feature may allow pet owners to connect the bag to a leash, belt, shoulder strap, or other item to facilitate ease of carrying the bag.

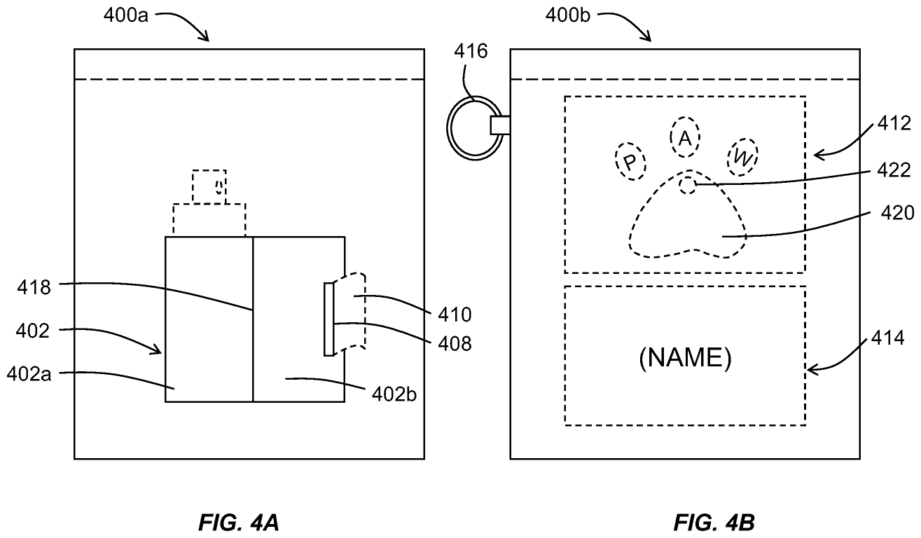

FIGS. 4A and 4B illustrate a front side 400a and a back side 400b, respectively, of another bag embodiment. Front side 400a may include a pocket 402 that is subdivided into a first sub-pocket 402a and a second sub-pocket 402b using, for example, a line of stitching, iron-on adhesive, or other means for tacking down an area (e.g., a line 418) of the pocket 402 between the first and second sub-pockets. The first and second sub-pockets may be different sizes (e.g., widths or volumes) or the same size. Both of the sub-pockets 402a, 402b may open along a top side while the left, right, and bottom sides are sealed against the main bag portion. In some embodiments, the first sub-pocket 402a may be configured to receive a bottle, such as a loz bottle of hand cleanser product (e.g., sanitizer, soap, water, etc.). The second sub-pocket 402b may be configured to receive a roll of pet waste bags as described with respect to FIG. 3A, above. Similar to pocket 306, sub-pocket 402b may include a slot 408 to allow a bag 410 from the roll of pet waste bags within sub-pocket 402b to be accessible from outside of the sub-pocket 402b.

FIG. 4B illustrates a back side 400b of a bag. The back side 400b includes a first region 412 with a “PAW” logo disposed therein. In this embodiment, the larger portion 420 of the “PAW” logo may be a pocket for additional storage. The pocket 420 may be selectively opened and closed with a fastener 422 which may be a snap, hook and loop, magnet, or other suitable fastener. A second region 414 on the back side 400b of the bag may be reserved for a pet name, an owner name, or other personalization or decorative graphic design. Similar to the bag described with respect to FIGS. 3A and 3B, the bag of FIGS. 4A and 4B also includes a ring 416 that may be used to connect the bag to a strap or a leash for easy carrying.

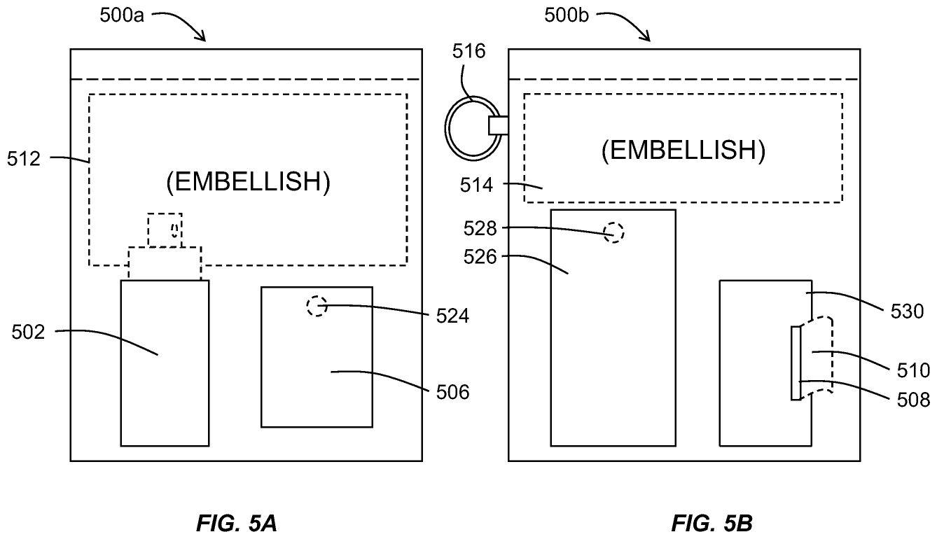

FIGS. 5A and 5B illustrate a front side 500a and a back side 500b, respectively, of another bag embodiment. Front side 500a includes a first pocket 502 configured to receive a hand soap or sanitizer bottle, similar to pocket 302 (FIG. 3A). The front side 500a further includes a second pocket 506 that may be sized differently (e.g., different height, width, and/or volume) than the first pocket 502. The second pocket may be sized to hold a small air freshener pod, for example. The second pocket 506 may include a fastener 524, such as a snap, hook and loop, magnet, zipper, or other selectively closing mechanism to retain the air freshener within the pocket. The second pocket may be sized between approximately 1 and approximately 3 inches in width and in height. Areas of the front side 500a that are not covered by pockets may be used for decorative purposes. For example, area 512 may be used for graphic design or other personalization as discussed above with respect to area 312.

A back side 500b of a bag is illustrated in FIG. 5B. The back side includes a pocket 526 that may be selectively opened and closed using a fastener 528 near the pocket opening (e.g., at the top of the pocket as shown). Pocket 526 may be used to hold pet treats or other items for the pet or pet owner. Pocket 530 may be similar to pocket 306 described with respect to FIG. 3B. Specifically, the pocket 530 may be configured to hold a roll of pet waste bags and may include a slit 508 therein to allow a portion of a bag 510 on the roll to protrude from the pocket for easy access. Portions of the back side 500b, such as area 514, may be used for graphic design or other personalization as discussed above with respect to area 312. The bag may include a ring 516 or other hardware for use in attaching the bag to another item.

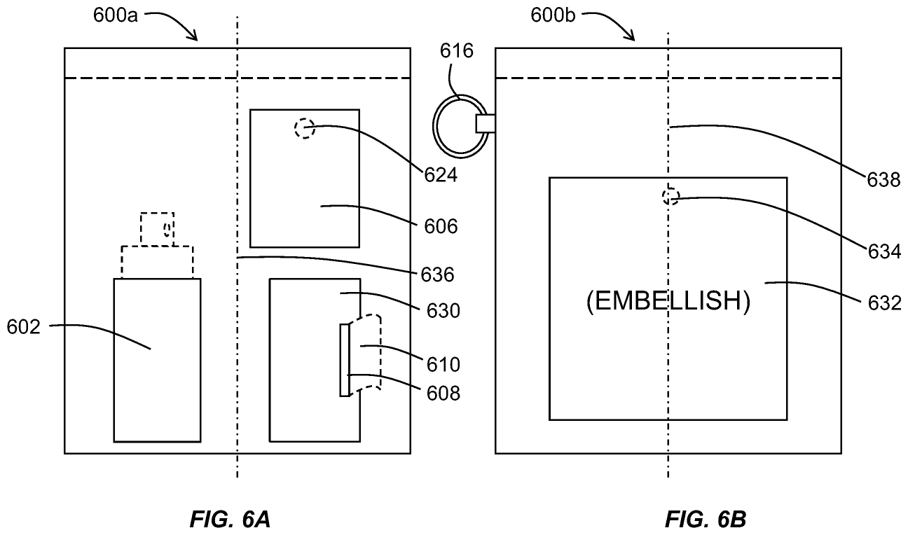

FIGS. 6A and 6B illustrate a front side 600a and a back side 600b, respectively, of another bag embodiment. Front side 600a includes a first pocket 602 configured to receive a hand soap or sanitizer bottle, similar to pocket 302 (FIG. 3A). The front side 600a further includes a second pocket 606 that may be sized differently (e.g., different height, width, and/or volume) than the first pocket 602. The second pocket may be sized to hold a small air freshener pod, keys, currency, or other smaller items for pets or owners, for example. The second pocket 606 may include one or more fasteners 624, such as snaps, hook and loop, magnets, zippers, buttons, or other selectively closable mechanisms to retain the air freshener or other contents within the pocket. The second pocket may be sized between approximately 1 and approximately 3 inches in width and/or in height. A third pocket 630 may also be included on front side 600a. The third pocket may be sized differently (e.g., have a different height, width, and/or volume) from the first or second pockets. The third pocket may be configured to receive a roll of pet waste bags and may include a slot 608 through a portion of the pocket such that a pet waste bag 610 may protrude from the pocket. The slot 608 allows easy access to the pet waste bags without having to remove the entire roll from the pocket 630. The relative arrangements of the different pockets on front side 600a may be adjusted and moved per aesthetic preference and sizes/aspect ratios of the pockets and the bag may also be adjusted. It may be desirable to space the pockets such that when the pockets are carrying contents therein, weight is distributed to both the left and right sides of the bag. Thus, in bags having more than one pocket on a given side (e.g., a front side or a back side), it may be desirable to include at least one pocket to a first (e.g., left) side of a bag centerline 636 and at least one pocket to a second (e.g., right) side of the bag centerline.

A back side 600b of a bag is illustrated in FIG. 6B. The back side includes a pocket 632 that may be selectively opened and closed using a fastener 634 near the pocket opening (e.g., at the top of the pocket as shown). Pocket 632 may be a larger pocket that can be used to hold pet treats, a collapsible bowl, pet wipes, hand wipes, or other items for the pet or pet owner. In some embodiments, the pocket 632 is lined with or made from a vinyl material so that water or food residue may be prevented from seeping through onto the user and may be easily rinsed out for improved hygiene. Because there is only a single pocket on the back side 600b, it may be advantageous to center or approximately center the pocket 632 with respect to a centerline 638 of the back side 600b. Such positioning may keep the bag from tipping or hanging awkwardly when the pocket is holding contents. The pocket may be placed along the centerline at any top-to-bottom position; however, it may be advantageous to lower the pocket 632 away from the top opening of the bag to avoid awkward tipping or hanging of the bag when contents are disposed therein. The pocket 632 may be sufficiently large to support a graphical design or other embellishment or personalization thereon. For example, as discussed above, the pocket 632 (or any other pocket on the bag) may be screen printed, embroidered, painted, patched, or otherwise decorated using any fabric, ink, paint, thread, or other material. Additionally, any other area of the front or back sides of the bag may be decorated or personalized per a user's preference. Hardware 616 is included on the bag to assist with carrying or attaching the bag to another object.

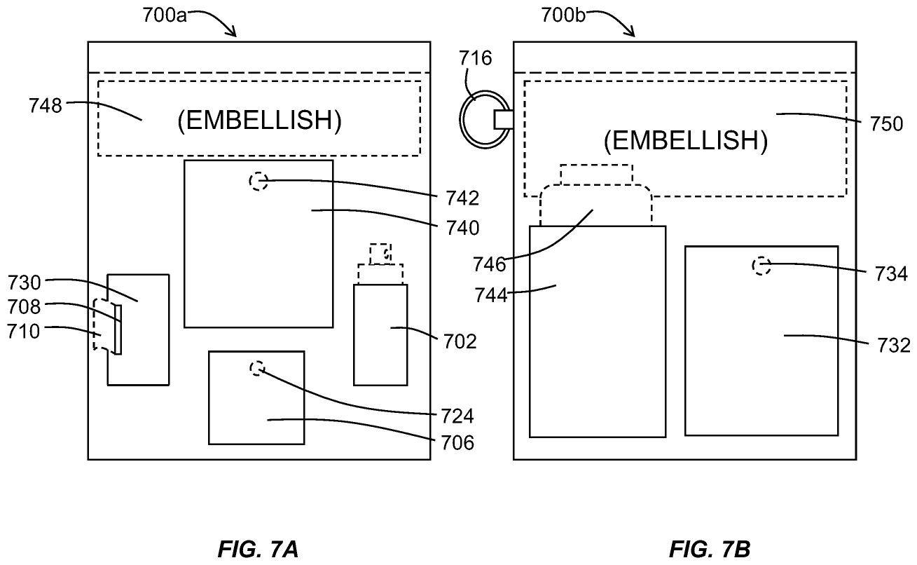

FIGS. 7A and 7B illustrate a front side 700a and a back side 700b, respectively, of another bag embodiment. The front and back sides 700a, 700b may be larger than previous embodiments described herein. For example, each of the front and back sides may be between approximately 8 and approximately 10 inches in width and may be between approximately 12 and approximately 16 inches in height. In some embodiments, the bag is approximately 9.5 inches in width and approximately 15 inches in height.

Front side 700a includes a first pocket 702 configured to receive a hand soap or sanitizer bottle similar to pocket 302 (FIG. 3A). The front side 700a further includes a second pocket 706 that may be sized differently (e.g., have a different height, width, and/or volume) than the first pocket 702. The second pocket may be sized to hold a small air freshener pod, keys, currency, credit cards, or other smaller items for pets or owners, for example. The second pocket 706 may include one or more fasteners 724, such as snaps, hook and loop, magnets, zippers, buttons, or other selectively closable mechanisms to retain the air freshener or other contents within the pocket. A third pocket 730 may also be included on front side 700a. The third pocket may be sized differently (e.g., have a different height, width, and/or volume) from the first or second pockets. The third pocket may be configured to receive a roll of pet waste bags and may include a slot 708 through a portion of the pocket such that a pet waste bag 710 may protrude from the pocket. The slot 708 allows easy access to the pet waste bags without having to remove the entire roll from the pocket 730. A fourth pocket 740 may also be included on first side 700a. The fourth pocket 740 may be sized differently than the first, second, or third pockets and may be sufficiently large to accommodate a collapsible water or food bowl, or other items for pets or owners. The fourth pocket may also include a fastener 742 different than or the same as fastener 724.

The relative arrangements of the different pockets on front side 700a may be adjusted and moved and the sizes/aspect ratios of the pockets and the bag may also be adjusted. It may be desirable to space the pockets such that when the pockets are carrying contents therein, weight is distributed to both the left and right sides of the bag. Thus, in bags having more than one pocket on a given side (e.g., a front side or a back side), it may be desirable to include at least one pocket to a first (e.g., left) side of a bag centerline and at least one pocket to a second (e.g., right) side of the bag centerline. Alternatively, multiple pockets may be arranged along the centerline to evenly distribute weight at the center of the bag. Any region of the bag, for example area 748, may be used for decorative purposes, personalization, or branding.

A back side 700b of a bag is illustrated in FIG. 7B. The back side includes a pocket 732 that may be selectively opened and closed using a fastener 734 near the pocket opening (e.g., at the top of the pocket as shown). Pocket 732 may be a larger pocket that can be used to hold pet treats, a collapsible bowl, pet wipes, hand wipes, or other items for the pet or pet owner. In some embodiments, the pocket 732 is lined with or made from a vinyl material so that water or food residue may be prevented from seeping through onto the user and may be easily rinsed out for improved hygiene. An additional pocket 744 is included on back side 700b of the bag and the pocket 744 may be configured to receive and hold a water bottle 746. The pocket 744 may be sized such that a standard sized water bottle protrudes from the top of the pocket; therefore, a fastener may not be required for this pocket. The pockets 732, 744 (or any other pocket on the bag) may be screen printed, embroidered, painted, patched, or otherwise decorated using any fabric, ink, paint, thread, or other material. Additionally, any other area, such as area 750, may be decorated or personalized per a user's preference. Hardware 716 is included on the bag to assist with carrying or attaching the bag to another object.

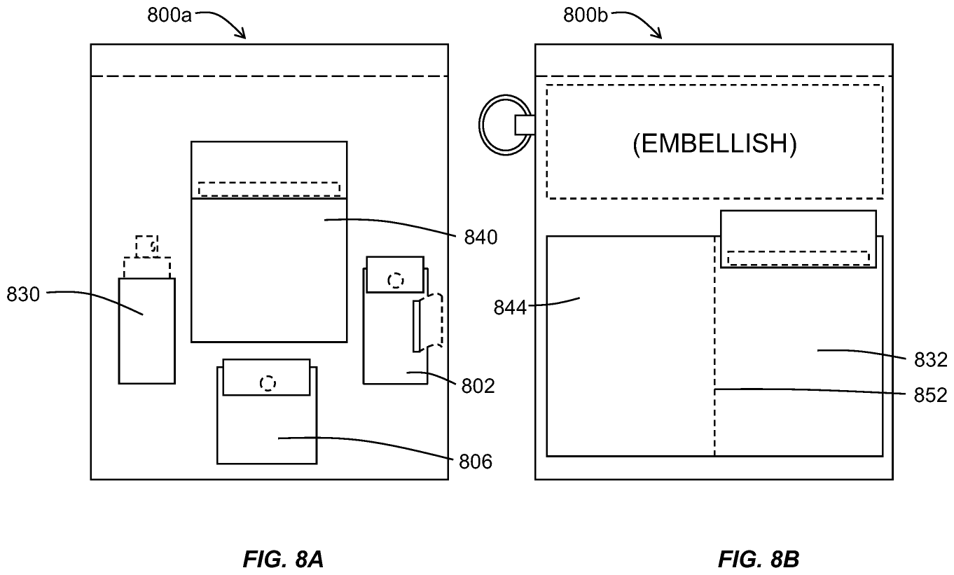

FIGS. 8A and 8B illustrate front and back sides 800a, 800b, respectively, of an alternate pocket configuration from that shown in FIGS. 7A and 7B. While the number, size, arrangement, and intended use of the pockets may be similar, the construction and means for securing items may be different. In particular, pockets configured to fully contain contents may include a flap closure secured by a fastener. For example, pocket 806 sized for an air freshener pod, pocket 802 sized and configured to hold and dispense a roll of pet waste bags, pocket 840 which may be vinyl-lined and configured to hold a collapsible pet bowl, and pocket 832 which may be vinyl-lined and configured to hold pet treats may include a flap closure with fastener (represented by dotted line feature). The fastener may be a zipper, strip of hook and loop, magnet, or other selectively closable mechanism. In addition to the alternate pocket closure style, pockets 844 and 832 disposed on the back side 800b may be formed by dividing one larger pocket into the two sub-pockets using, for example, a line of stitching 852.

While pockets and bags are illustrated having certain sizes or aspect ratios, any suitable sizes may be selected as a matter of design choice. Additionally, while pockets and other features are shown in certain positions relative to each other and relative to particular sides or openings on the bag, many arrangements are possible without departing from the scope of the present disclosure.

Accordingly, many different embodiments stem from the above description and the drawings. It will be understood that it would be unduly repetitious and obfuscating to literally describe and illustrate every combination and subcombination of these embodiments. As such, the present specification, including the drawings, shall be construed to constitute a complete written description of all combinations and subcombinations of the embodiments described herein, and of the manner and process of making and using them, and shall support claims to any such combination or subcombination.

1. A selectively closable pet waste bag comprising:
a bag body comprising:
an outer layer comprising a front side and a back side; and
an inner layer disposed within the outer layer and configured to line the outer layer,
wherein the inner layer defines an inner pouch compartment having an opening,
wherein the inner layer is formed from a waterproof material, and
wherein the outer layer comprises at least one pocket disposed thereon; and
a closing mechanism configured to selectively close the opening of the inner pouch.

2. The selectively closable pet waste bag of claim 1, wherein the waterproof material is a vinyl material.

3. The selectively closable pet waste bag of claim 1, wherein the inner layer is selectively removable from the bag body.

4. The selectively closable pet waste bag of claim 1, wherein the bag body has a bag width dimension and a bag height dimension, and wherein the width dimension is less than approximately 12 inches and the height dimension is less than approximately 16 inches.

5. The selectively closable pet waste bag of claim 4, wherein the bag width dimension is greater than approximately 6 inches and the bag height dimension is greater than approximately 8 inches.

6. The selectively closable pet waste bag of claim 1, wherein the at least one pocket comprises a waste bag pocket having a waste bag pocket width less than 4 inches and a waste bag pocket height less than 6 inches.

7. The selectively closable pet waste bag of claim 6, wherein the waste bag pocket has a slit between an interior of the waste bag pocket and an exterior of the waste bag pocket.

8. The selectively closable pet waste bag of claim 7, wherein the slit is configured such that a waste bag from a roll of waste bags disposed within the waste bag pocket is configured to extend through the slit.

9. The selectively closable pet waste bag of claim 7, wherein a length of the slit is between approximately 1 inch and approximately 2 inches.

10. The selectively closable pet waste bag of claim 7, further comprising a waste bag pocket fastener configured to selectively close a waste bag pocket opening of the waste bag pocket.

11. The selectively closable pet waste bag of claim 1, wherein the at least one pocket comprises a bottle pocket having a bottle pocket width less than approximately 3 inches and a bottle pocket height less than approximately 6 inches.

12. The selectively closable pet waste bag of claim 1, wherein the closing mechanism comprises a drawstring.

13. The selectively closable pet waste bag of claim 1, further comprising a ring configured to connect the selectively closable bag to a pet leash.

14. The selectively closable pet waste bag of claim 1, further comprising a looped strap configured to be worn around a user's wrist.

15. The selectively closable pet waste bag of claim 1, wherein the outer layer comprises at least two pockets.

16. The selectively closable pet waste bag of claim 15, wherein each of the at least two pockets have different sizes in at least one of a width and a height dimension.

17. The selectively closable pet waste bag of claim 15, wherein the outer layer comprises at least three pockets.

18. The selectively closable pet waste bag of claim 16, wherein each of the at least three pockets have different sizes in at least one of a width and a heigh dimension.

19. The selectively closable pet waste bag of claim 1, wherein each of the front side and the back side of the outer layer have a pocket disposed thereon.

20. A selectively closable pet waste bag comprising:
a bag body comprising:
a front side and a back side; and
an inner pouch compartment having a selectively closable opening,
wherein the bag body is formed from a waterproof material;
at least one pocket disposed on an exterior surface of the bag body; and
a closing mechanism configured to selectively close the opening of the inner pouch.
